(19) United States
(12) Patent Application Publication
(10) Pub. No.: US 2015/0059327 A1
(43) Pub. Date: Mar. 5, 2015

(54) DUAL CHANNEL PULSED VARIABLE PRESSURE HYDRAULIC TEST APPARATUS

(71) Applicant: Arthur M. Rabert, Manchester, NH (US)

(72) Inventor: Arthur M. Rabert, Manchester, NH (US)

(21) Appl. No.: 14/374,263

(22) PCT Filed: Feb. 24, 2014
(86) PCT No.: PCT/US2014/018815

§ 371 Date: Jul. 24, 2014

Related U.S. Application Data
(60) Provisional application No. 61/812,798, filed on Apr. 17, 2013.

(51) Int. Cl. F15B 1/033; F15B 21/08; F15B 21/12

(52) U.S. Cl. CPC F15B 1/033; F15B 21/12; F15B 21/08; F15B 2211/212; F15B 2211/6309
USPC 60/418

(57) ABSTRACT

A fast and flexible pressure testing apparatus includes two parallel pressure channels having independent pumps and pressure regulators. Pressure pulse cycle times are minimized by using large diameter hydraulic lines. A fluid accumulator in each channel stores pre-pressurized fluid to avoid pressure delivery delays due to limited pump output. In embodiments, the outputs of the two delivery channels can be combined to deliver pressure pulses to the part under test (PUT) from either channel in any desired sequence, or one channel can be used to return the PUT to its initial status. Embodiments gate the pressure pulses using servo valves, which can have pressure outputs that are proportional to their control signals, thereby enabling shaped output pressure profiles according to shaping of the control signals. The pressure channels can be further split into first and second branches which set the ranges over which the channel output can be varied.

### RELATED APPLICATIONS

This application claims the benefit of U.S. Provisional Application No. 61/812,798, filed Apr. 17, 2013, which is herein incorporated by reference in its entirety for all purposes.

### FIELD OF THE INVENTION

The invention relates to hydraulic apparatus, and more particularly, to apparatus for pulsed pressure testing of hydraulic apparatus sealing components.

### BACKGROUND OF THE INVENTION

Hydraulic systems are widely used in many industries. Examples include motor vehicle engines, braking systems, aeronautical control systems, industrial pumping systems, presses, rolling mills, earth-moving equipment, floor conveyors, agricultural machines, truck loading cranes, injection molding machines, marine hydraulics, and many others.

So as to ensure reliability and longevity even under challenging conditions, it is often necessary to submit hydraulic designs to rigorous and prolonged pressure testing, so as to ensure that there is no excessive material fatigue or seal wear even after long term, demanding use. For certain applications, the pressure testing requires repeated application and release of a specified hydraulic pressure to the part under test (“PUT”). This “pulsed pressure” testing is typically carried out for a specified number of pressure cycles.

FIG. 1 illustrates a typical test apparatus that is used for pulsed pressure hydraulic testing. A rotary pump 100 pressurizes hydraulic fluid, and a manually controlled regulator 102 controls the pressure at the output of the pump 100 by allowing some of the hydraulic fluid to flow into a reservoir 104. The regulator 102 is manually adjusted until the pressure at the output of the pump 100 is set to a desired pressure P as measured by a pressure measuring device 106, such as a pressure gage.

The output of the pump 100 is also connected through a solenoid control valve 108 to the PUT 110. The solenoid valve 108 is opened and closed by a control signal 112, which is typically supplied as a train of “square” voltage pulses 112 that cause the system to repetitively apply the hydraulic pressure P to the PUT, and then to release the pressure again. Typically, a counter (not shown) counts the voltage pulses 112, and stops the test after a specified number of repetitions N has been applied. If the PUT does not include a mechanism that returns it to its starting configuration after each pressure pulse is applied, then a return spring 114 or other such mechanism is provided.

As testing requirements have become more demanding and sophisticated, for example requiring 360,000 pressure pulse cycles or more, the maximum rate at which hydraulic testing apparatus can apply pressure pulses has often proven to be too slow, due to pressure delays in the hydraulic lines and limitations in the operating speed of the solenoid valve. In particular, it is not uncommon for the solenoid valve to require 60 ms or more to switch on and off. As a result, weeks or even months may be required to apply a specified number of pressure pulses to the PUT.

In addition, systems such as the apparatus illustrated in FIG. 1 are limited to a single applied pressure, and are unable to apply hydraulic fluid to the PUT at more than one pressure during a test.

What is needed, therefore, is a hydraulic testing apparatus that is faster and more flexible than current designs.

### SUMMARY OF THE INVENTION

The present invention is an enhanced pressure testing apparatus that is faster and more flexible than current designs. Pressure delays in the hydraulic lines are minimized by using hydraulic lines that are significantly larger in diameter than previous designs. For example, lines that are 1¼ inches in diameter are used in some embodiments for applications where ¼ inch diameter lines have typically been used in the past. A fluid accumulator is used to avoid pump output capacity delays by storing a volume of hydraulic fluid that is pre-pressurized while the control valve is closed, and then supplements the pump output when the control valve is open. Delays that might otherwise arise due to the enlarged volume of the hydraulic lines are thereby avoided.

Rather than providing only a single pressure delivery channel, the present invention includes two pressure delivery channels, each of which includes its own pump, regulator, accumulator, and control valve. As a result, a PUT that requires a separately applied pneumatic pressure to return it to its initial configuration can be easily accommodated. And in some embodiments, if it is desirable to apply pressure to a single input of the PUT at two different pressure values, for example alternately, the outputs of the two delivery channels can be combined at the input of the PUT.

Embodiments of the present invention use servo valves, which typically switch much faster than solenoid valves (for example 10 ms switching time for a servo valve compared to 60 ms for a solenoid valve). In some of these embodiments, output signals of pressure transducers provided at the outputs of the servo valves are used by feedback comparators in a “proportional integral and derivative” (“PID”) loop to obtain a desired pressure output from each servo valve. In various embodiments, by controlling and shaping the servo valve control voltages, a wide range of different pressure outputs, and even pressure output profiles, can be provided on either or both pressure channels.

In some embodiments, the hydraulic pump is a variable-vane pump, which allows the system to adapt to a wider range of pressure requirements and PUT volumes.

Certain embodiments further include selectable high and low pressure ranges on one or both of the pressure channels. In some of these embodiments, the hydraulic output of the pump is split into two parallel channels, passed through parallel regulators, accumulators, and control valves, and then recombined.

The present invention is a system for applying hydraulic pressure pulses to a part under test (“PUT”). The system includes:

a first pressure channel including:
a first pump configured to pressurize hydraulic fluid in the first pressure channel;
a first fluid accumulator in fluid communication with an output of the first pump;
a first regulator configured to establish a first fluid pressure in the first fluid accumulator; and
a first control valve having a first pressure channel output in fluid communication with the PUT, the first pressure channel output being switchable by the first control valve between fluid communication with the first accumulator and fluid communication with a hydraulic fluid reservoir, the first control valve being actuated by a first electrical control signal received from a system controller; and
   a second pressure channel including:
a second pump configured to pressurize hydraulic fluid in the second pressure channel;
a second fluid accumulator in fluid communication with an output of the second pump;
a second regulator configured to establish a second fluid pressure in the second fluid accumulator; and
a second control valve having a second pressure channel output in fluid communication with the PUT, the second pressure channel output being switchable by the second control valve between fluid communication with the second accumulator and fluid communication with the hydraulic fluid reservoir, the second control valve being actuated by a second electrical control signal received from the system controller.

Embodiments further include a first pressure transducer configured to measure a pressure of the first pressure channel output and a second pressure transducer configured to measure a pressure of the second pressure channel output.

In some embodiments at least one of the control valves is a servo valve. In some of these embodiments the output of the servo valve provides a variable pressure channel output according to a varying amplitude of the corresponding electrical control signal. In other of these embodiments the variable pressure channel output is linearly proportional to the varying amplitude of the corresponding electrical control signal.

In various embodiments the first pressure channel output and the second pressure channel output can be combined and applied jointly to the PUT, thereby allowing the system controller to apply pressure from either pressure channel to the PUT in any desired sequence.

In certain embodiments, the output of the first pump is in simultaneous fluid communication with a high pressure branch and a low pressure branch, each of the high and low pressure branches including a pressure regulator, a fluid accumulator, and a control valve, outputs of the high and low pressure branches being in combined fluid communication with the first control valve, so that a fluid pressure delivered to the first control valve is selectable between a pressure set by the high pressure branch regulator and a pressure set by the low pressure branch regulator. And in some of these embodiments the first control valve is a servo valve that provides a variable pressure output according to a variable electrical control signal, selection of the high or low pressure channel thereby selecting between a high pressure range and a low pressure range over which the first control valve is able to vary the first pressure channel output.

And in various embodiments at least one of the first and second pumps is a variable vane pump.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a prior art configuration of a hydraulic testing apparatus;

FIG. 2 is a block diagram illustrating an embodiment of the present invention;

FIG. 3 is a block diagram that illustrates combining of both pressure channel outputs into a single PUT input in an embodiment of the present invention;

FIG. 4A is a graphical illustration of a basic pressure pulsing cycle;

FIG. 4B is a graphical illustration of a pressure pulsing cycle that includes pressure profiles in an embodiment of the present invention; and

FIG. 5 is a block diagram that illustrates an embodiment of the present invention that provides selectable high and low pressure ranges on both pressure channels.

### DETAILED DESCRIPTION

The present invention is an enhanced pressure testing apparatus that is faster and more flexible than current designs. Pressure delays in the hydraulic lines are minimized by using hydraulic lines that are larger in diameter than previous designs. For example, lines that are 1¼ inches in diameter are used in some embodiments for applications where ¼ inch diameter lines have typically been used in the past.

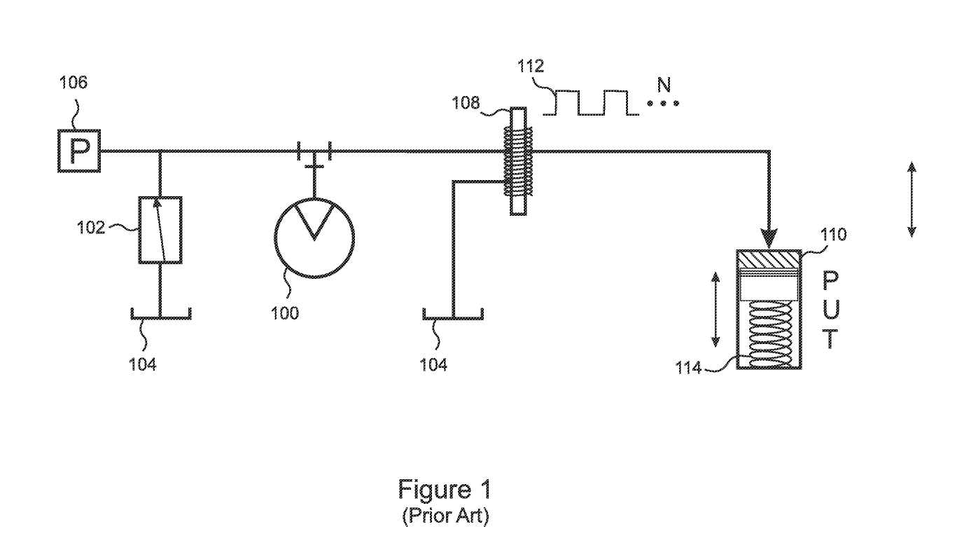

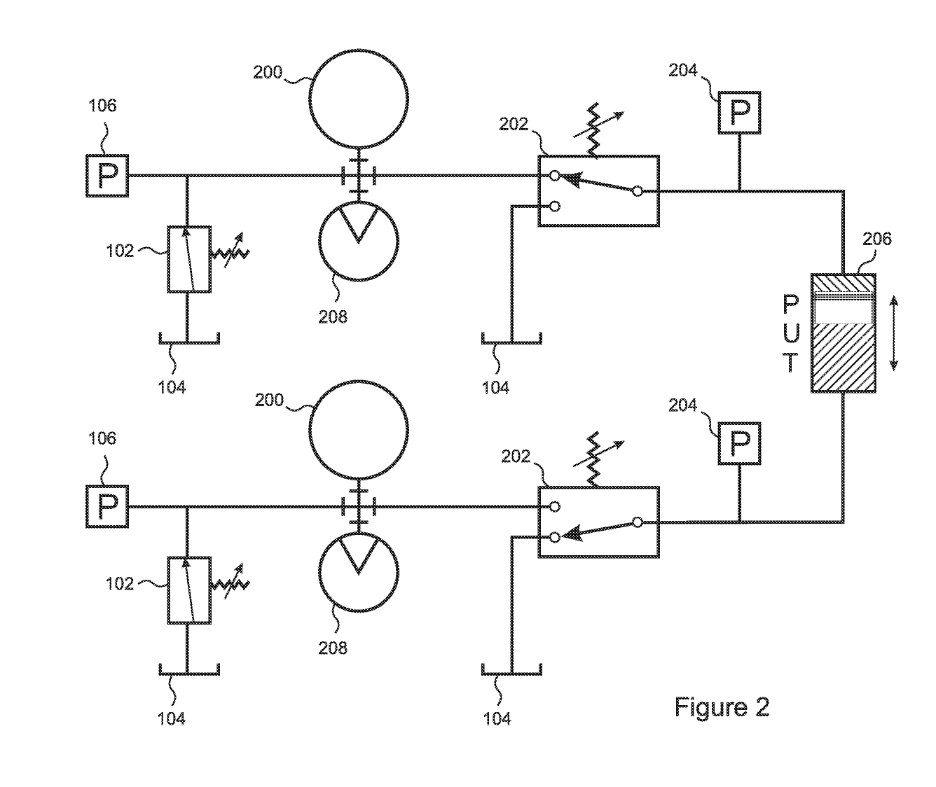

With reference to FIG. 2, rather than providing only a single pressure delivery channel, the present invention includes two pressure delivery channels, each of which includes its own pump, which can be a rotary pump 100 as shown in FIG. 1, or a variable-vane pump 208 as shown in FIG. 2. Each pressure delivery channels further includes a regulator 102 and control valve, which in some embodiments is a solenoid valve 108 and in other embodiments is a servo valve 202. As a result, a PUT 206 that requires separately applied pneumatic pressure to return to its initial configuration can be easily accommodated.

In addition, each pressure channel includes a fluid accumulator 200 in which a volume of hydraulic fluid is pre-pressurized while the control valve 202 is closed, and then supplements the pump output when the control valve 202 is open, so that the larger volume of the hydraulic lines does not cause pressure delivery delays due to limited pump output capacity.

Embodiments of the present invention use servo valves 202, which typically switch much faster than solenoid valves (for example 10 ms switching time for a servo valve 108 compared to 60 ms for a solenoid valve 202). In some of these embodiments, pressure transducers 204 are provided at the outputs of the servo valves 202, and the outputs of the pressure transducers 204 are used by feedback comparators (not shown) in a “proportional integral and derivative” (“PID”) loop to obtain a desired pressure output from each servo valve 202. In various embodiments, by controlling and shaping the valve control voltages, a wide range of different pressure outputs, and even pressure output profiles, can be provided on either or both pressure channels.

In some embodiments, the hydraulic pump 208 is a variable-vane pump 208, which allows the system to adapt to a wider range of pressure requirements and PUT volumes as compared to a rotary pump 100.

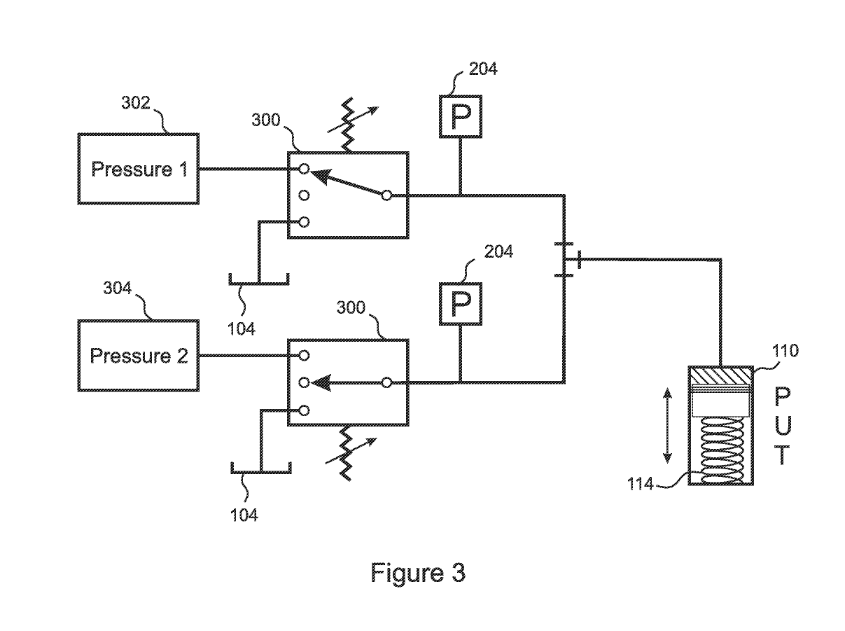

With reference to FIG. 3, in some embodiments where the PUT 110 does not require separately applied pneumatic pressure to return to its initial configuration, if it is desirable to apply pressure to the single input of the PUT 110 at two different pressure values, for example alternately, the outputs of the two delivery channels can be combined at the input of the PUT 110. In the embodiment of FIG. 3, the servo valves 300 are able to switch their outputs between the input pressure channel 302, 304, the fluid reservoir 104, and a blocked input. Accordingly, as is illustrated in the figure, when one of the pressure channel outputs 302 is applying hydraulic pressure to the PUT 110, the output of the other pressure channel 304 can be blocked so that it will not interfere. The valves 300 can then be switched so that the pressure is drained into the reservoir 104, after which the first pressure channel output 302 can be blocked while the second pressure channel output 304 applies hydraulic pressure to the PUT 110.

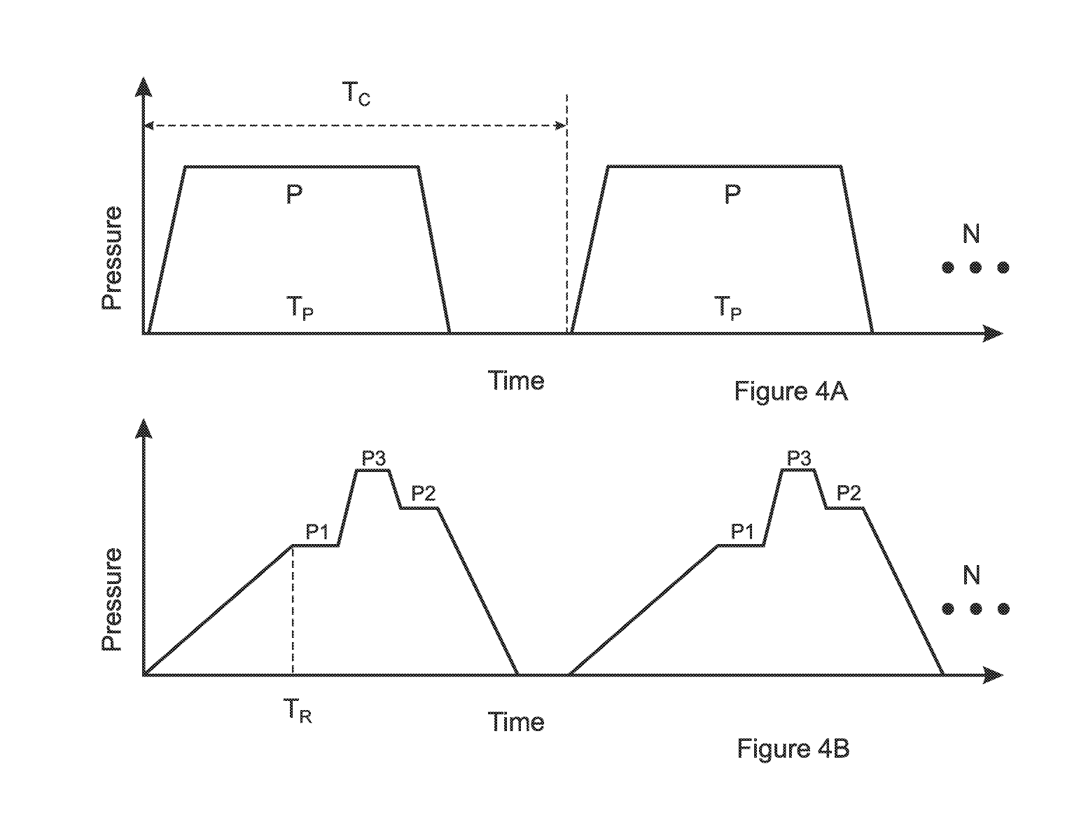

With reference to FIG. 4A, in some embodiments the present invention can produce a series of pressure pulses that rise rapidly to a pre-set pressure P, and then fall again after a pulse duration Tp. The pulses are repeated with a cycle time Tc until a total desired number N of pulses has been applied.

With reference to FIG. 4B, in other embodiments the control valves 202 are servo valves 202 having output pressures that are proportional to the amplitude of the control voltage. In some of these embodiments, pressure pulses having shaped profiles can be applied to the PUT 206 by applying control voltages with corresponding shape profiles to the servo valves 202. In the embodiment of FIG. 4B, the pressure is ramped at a controlled rate to a first pressure Pl, where it is held for a set amount of time, after which it is ramped up to a second pressure P2, followed by a third pressure P3, before being released at a controlled rate. In similar embodiments, pressure profiles of almost any arbitrary shape can be applied.

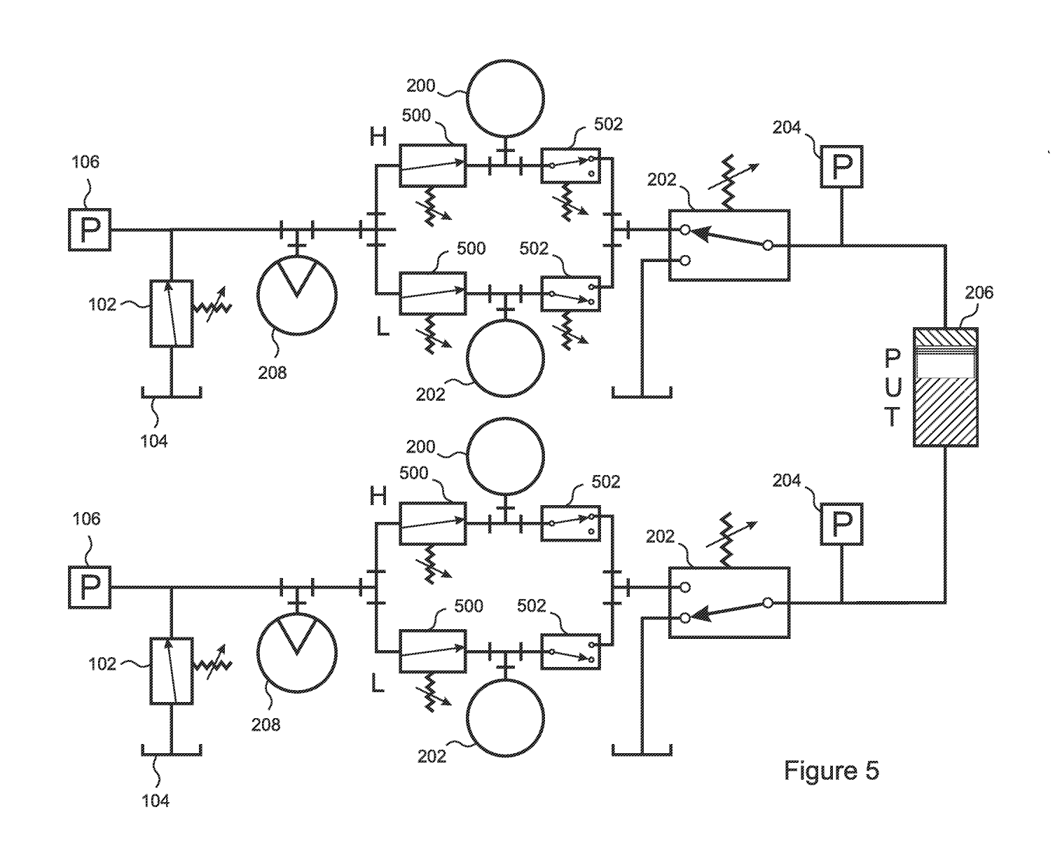

With reference to FIG. 5, certain embodiments further include selectable high and low pressure ranges on one or both of the pressure channels. In the embodiment of FIG. 5, the output of a variable vane hydraulic pump 208 in each pressure channel is split into two parallel branches, passed through parallel regulators 500, accumulators 200, and control valves 502, and then recombined. Each of the parallel branch regulators 500 is set to a desired pressure, which determines the range over which the primary control valve 202 in that channel can vary the output pressure. The dedicated fluid accumulator in each branch is pre-pressurized to the set pressure for its parallel branch while the other branch is in use, and then drives the fluid output of its branch when needed. In similar embodiments, a single accumulator provided at the output of the pump is pre-pressurized to the pressure of the pump output when neither pressure branch is in use, and then drives the pressure output when one of the pressure branches is in use.

In embodiments, the control voltages are supplied to the control valves 202 by programmable logic controllers (“PLC's”), and in some embodiments operator control is available through a graphical user interface such as LabView. In various embodiments, the system displays the pressures measured by the pressure transducers 106, 204 as well as the number of completed cycles N, and in some embodiments these parameters are periodically recorded and logged for later review. In similar embodiments, the current and/or logged values of these parameters can be monitored remotely using any internet-capable device.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for applying hydraulic pressure pulses to a part under test (“PUT”), the system comprising:
a first pressure channel comprising:
a first pump configured to pressurize hydraulic fluid in the first pressure channel;
a first fluid accumulator in fluid communication with an output of the first pump;
a first regulator configured to establish a first fluid pressure in the first fluid accumulator; and
a first control valve having a first pressure channel output in fluid communication with the PUT, the first pressure channel output being switchable by the first control valve between fluid communication with the first accumulator and fluid communication with a hydraulic fluid reservoir, the first control valve being actuated by a first electrical control signal received from a system controller; and
a second pressure channel comprising:
a second pump configured to pressurize hydraulic fluid in the second pressure channel;
a second fluid accumulator in fluid communication with an output of the second pump;
a second regulator configured to establish a second fluid pressure in the second fluid accumulator; and
a second control valve having a second pressure channel output in fluid communication with the PUT, the second pressure channel output being switchable by the second control valve between fluid communication with the second accumulator and fluid communication with the hydraulic fluid reservoir, the second control valve being actuated by a second electrical control signal received from the system controller.

2. The system of claim 1, further comprising a first pressure transducer configured to measure a pressure of the first pressure channel output and a second pressure transducer configured to measure a pressure of the second pressure channel output.

3. The system of claim 1, wherein at least one of the control valves is a servo valve.

4. The system of claim 3, wherein the output of the servo valve provides a variable pressure channel output according to a varying amplitude of the corresponding electrical control signal.

5. The system of claim 4, wherein the variable pressure channel output is linearly proportional to the varying amplitude of the corresponding electrical control signal.

6. The system of claim 1, wherein the first pressure channel output and the second pressure channel output can be combined and applied jointly to the PUT, thereby allowing the system controller to apply pressure from either pressure channel to the PUT in any desired sequence.

7. The system of claim 1, wherein the output of the first pump is in simultaneous fluid communication with a first pressure branch and a second pressure branch, each of the first and second pressure branches including a pressure regulator, a fluid accumulator, and a control valve, outputs of the first and second pressure branches being in combined fluid communication with the first control valve, so that a fluid pressure delivered to the first control valve is selectable between a pressure set by the first pressure branch regulator and a pressure set by the second pressure branch regulator.

8. The system of claim 7, wherein the first control valve is a servo valve that provides a variable pressure output according to a variable electrical control signal, selection of the first or second pressure channel thereby selecting between a first pressure range and a second pressure range over which the first control valve is able to vary the first pressure channel output.

9. The system of claim 1, wherein at least one of the first and second pumps is a variable vane pump.
